(19) United States
(12) Patent Application Publication
(10) Pub. No.: US 2019/0386594 A1
(43) Pub. Date: Dec. 19, 2019

(54) MOTOR CONTROL APPARATUS DRIVING ONE MAIN AXIS SWITCHINGLY BY TWO MOTORS

(71) Applicant: Fanuc Corporation, Yamanashi (JP)

(72) Inventors: Ryoutarou Tsuneki, Minamitsuru-gun (JP); Satoshi Ikai, Yamanashi (JP)

(73) Assignee: Fanuc Corporation, Yamanashi (JP)

(21) Appl. No.: 16/436,078

(22) Filed: Jun. 10, 2019

(30) Foreign Application Priority Data
Jun. 14, 2018 (JP) 2018-113830

(51) Int. Cl. H02P 21/00; H02P 21/14; H02P 5/74; G05B 9/02; G06F 13/28

(52) U.S. Cl. CPC H02P 21/0003; H02P 21/14; G06F 13/28; G05B 9/02; H02P 5/74

(57) ABSTRACT

A motor control apparatus includes a switching unit configured to selectively switch a motor driving one main axis between two motors, a position detection unit configured to detect position information of the main axis, two motor control units provided correspondingly to each of the two motors, an abnormality detection unit configured to detect abnormality of a motor driving the main axis between the two motors, and a safety control unit configured to switch the motor driving the main axis, from the motor in which the abnormality is detected to a motor in which no abnormality is detected, and configured to stop the motor in which no abnormality is detected to stop the main axis, when the abnormality detection unit detects abnormality of the motor driving the main axis.

### BACKGROUND OF THE INVENTION

### 1. Field of Invention

The present invention relates to a motor control apparatus driving one main axis switchingly by two motors.

### 2. Description of the Related Art

There is a machine tool driving one main axis by selectively switching between a servomotor and a spindle motor. In such a machine tool, a suitable motor driving a main axis is used depending on a purpose in such a way that, for example, the main axis is driven by a servomotor during positioning, and the main axis is driven by a spindle motor during high-speed rotation.

For example, as described in Japanese Unexamined Patent Application Publication No. 2015-122932, there is known a control apparatus of a robot, including a drive axis for driving a movable portion specifying an operation of a robot, a master motor for rotationally driving the drive axis via a master power transmission mechanism, a slave motor for rotationally driving the drive axis via a slave power transmission mechanism, and a position detector for detecting a current position of the master motor, the control apparatus of a robot including: a first current command value generation unit for generating a current command value (hereinafter, a first current command value) to the master motor, based on a deviation (hereinafter, a master position deviation) between a position command value to the master motor and a value indicating a current position of the master motor detected by the position detector; a second current command value generation unit for generating a current command value (hereinafter, a second current command value) to the slave motor, based on the master position deviation or a predetermined torque command value; a first current deviation monitoring unit for monitoring a deviation (hereinafter, a first current deviation) between a current value depending on output torque generated, based on the first current command value, by the master motor, and the first current command value; a second current deviation monitoring unit for monitoring a deviation (hereinafter, a second current deviation) between a current value depending on output torque generated, based on the second current command value, by the slave motor, and the second current command value; and a current command value changing unit for changing the first current command value and/or the second current command value in such a way that a difference between the first current deviation and the second current deviation becomes smaller when the difference between the first current deviation and the second current deviation is equal to or more than a predetermined threshold value.

For example, as described in Japanese Unexamined Patent Application Publication No. 2003-079180, there is known a motor control apparatus for performing tandem control of driving one movable portion by use of a master axis motor and a slave axis motor, the control apparatus including, for each of the motors, a position control unit for calculating a speed command of a corresponding motor, based on a common position command for controlling a position of a movable portion, a speed control unit for calculating a torque command of a corresponding motor, based on a speed command calculated by the position control unit, and a current control unit for calculating a current command of a corresponding motor, based on the torque command calculated by the speed control unit, the motor control apparatus including a torque adjustment unit for performing low pass filter processing for a difference between a torque command calculated by the speed control unit corresponding to the master axis motor and a torque command calculated by the speed control unit corresponding to the slave axis motor, and calculating a torque adjustment value for correcting a torque command of a slave axis, wherein the torque command of the slave axis is corrected.

For example, as described in Japanese Unexamined Patent Application Publication No. 2006-252392, there is known a synchronous control apparatus for driving a slave operation axis by a motor in such a way as to synchronize the slave operation axis with a position of one master operation axis, the synchronous control apparatus including: a main axis position detection means for detecting a main axis position being a position of the master operation axis; a main axis speed detection means for detecting a main axis speed being a speed of the master operation axis; a main axis acceleration detection means for detecting main axis acceleration being acceleration of the master operation axis; a driven axis drive control apparatus for driving and controlling a driven axis motor being the motor driving the slave operation axis; a data transfer means for transferring, to the driven axis drive control apparatus, main axis data including at least either the main axis position or a corrected main axis position; a main axis speed correction means for generating a corrected main axis speed by adding, to the main axis speed, a product of a transfer time required to transfer the main axis data via the data transfer means, and the main axis acceleration; and a main axis position correction means for generating the corrected main axis position by adding, to the main axis position, a product of the corrected main axis speed and the transfer time, wherein the driven axis drive control apparatus includes a position control means for designating the corrected main axis position as a position command of the slave operation axis, and generating a speed command, based on the position command and a position of the slave operation axis, a speed control means for generating a current command, based on a sum of the speed command and the corrected main axis speed, and a speed of the slave operation axis, and a current control means for controlling supply current to the driven axis motor, based on a sum of the current command, and a value in which the main axis acceleration is multiplied by a predetermined coefficient.

### SUMMARY OF INVENTION

In a machine tool driving one main axis by selectively switching between a servomotor and a spindle motor, there is a possibility that, in a case where either the servomotor or the spindle motor has abnormality, a mechanism including a main axis fails when the motor having abnormality is left as it is and then the other motor is actuated. Therefore, in a motor control apparatus selectively switching a motor driving one main axis between two motors, a technique being capable of ensuring safety of a main axis even when a motor has abnormality is desired.

According to one aspect of the present disclosure, a motor control apparatus includes: a switching unit configured to selectively switch a motor driving one main axis between two motors; a position detection unit for detecting position information of the main axis; two motor control units being provided correspondingly to the respective two motors, and each configured to control the motor by use of the position information; an abnormality detection unit configured to detect abnormality of a motor driving the main axis between the two motors; and a safety control unit configured to control the switching unit to switch the motor driving the main axis, from the motor in which the abnormality is detected to a motor in which no abnormality is detected, and also configured to control the motor control unit to stop the motor in which no abnormality is detected to stop the main axis, when the abnormality detection unit detects abnormality of the motor driving the main axis.

### BRIEF DESCRIPTION OF THE DRAWINGS

The present invention will be more clearly understood with reference to the following accompanying drawings:

FIG. 1 is a diagram illustrating a motor control apparatus according to one embodiment of the present disclosure;

FIGS. 2A and 2B are diagrams illustrating one example of a switching operation by a switching unit in the motor control apparatus according to the embodiment of the present disclosure;

FIG. 3 is a flowchart illustrating an operation flow of the motor control apparatus according to the embodiment of the present disclosure; and

FIG. 4 is a diagram illustrating a motor control apparatus according to a further embodiment of the present disclosure.

### DETAILED DESCRIPTION

A motor control apparatus driving one main axis switchingly by two motors will be described below with reference to the drawings. In each drawing, similar components are indicated with similar reference signs. Further, the drawings use different scales as appropriate for ease of understanding. Further, a mode illustrated in the drawings is an example for implementing the present invention, and the present invention is not limited to the illustrated embodiments.

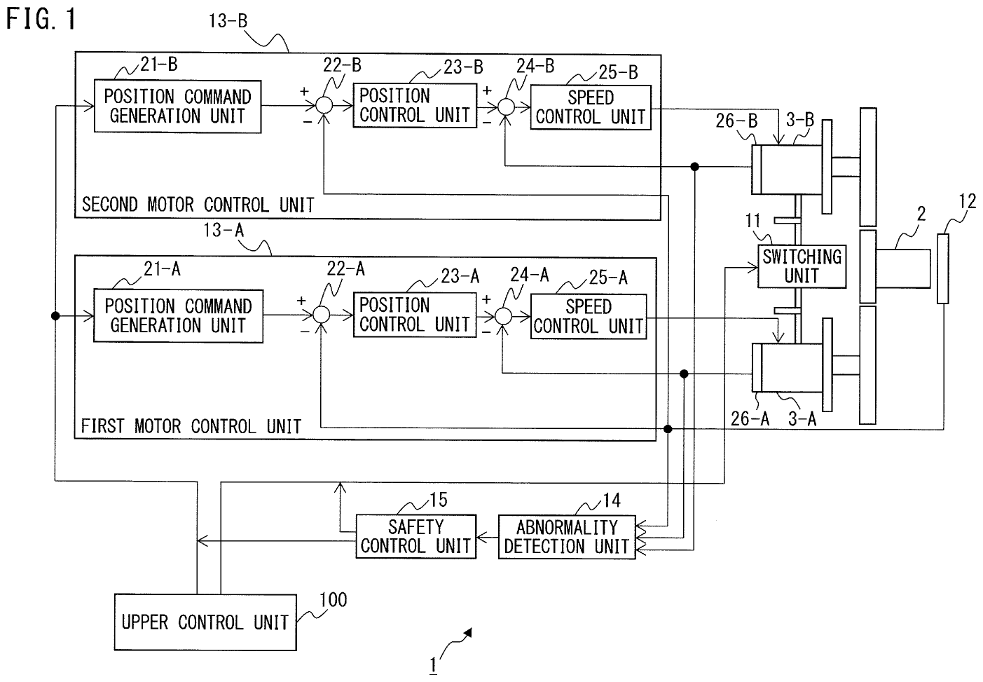

FIG. 1 is a diagram illustrating a motor control apparatus according to one embodiment of the present disclosure.

A motor control apparatus 1 according to the embodiment of the present disclosure includes a switching unit 11, a position detection unit 12, a first motor control unit 13-A, a second motor control unit 13-B, an abnormality detection unit 14, and a safety control unit 15. The motor control apparatus 1 also includes an upper control unit 100.

The upper control unit 100 controls operations of the first motor control unit 13-A, the second motor control unit 13-B, and the switching unit 11, based on an operation program prescribed in advance for an operation of a main axis 2. As an example of the upper control unit 100, there is a numerical value control apparatus of a machine tool, and the like. Note that, as described later, the operations of the first motor control unit 13-A, the second motor control unit 13-B, and the switching unit 11 are also controlled by the safety control unit 15.

The motor control apparatus 1 controls a motor driving the one main axis 2 by selectively switching between a first motor 3-A and a second motor 3-B. Although, in FIG. 1, illustration is omitted with regard to a power supply for supplying drive power to the first motor 3-A and the second motor 3-B, and a power converter, the motor control apparatus 1 includes, for example, a rectifier, and a first and a second amplifiers. AC power supplied from an AC power supply is converted into DC power by the rectifier (not illustrated), and then output to a DC link. Voltage in the DC link is applied to the first amplifier (not illustrated) driving the first motor 3-A, and the second amplifier (not illustrated) driving the second motor 3-B. The first amplifier and the second amplifier are each configured with, for example, an inverter composed of a full bridge circuit of a semiconductor switching element. The first amplifier converts DC power in the DC link into AC power, and then supplies the AC power to the first motor 3-A. The second amplifier converts DC power in the DC link into AC power, and then supplies the AC power to the second motor 3-B. Since a speed, torque, or a position of rotor is controlled in the first motor 3-A and the second motor 3-B, based on, for example, voltage-variable and frequency-variable AC power supplied from the first amplifier and the second amplifier, respectively, control of the first motor 3-A and the second motor 3-B is achieved by controlling respective power conversion operations in the first amplifier and the second amplifier. In other words, the first motor control unit 13-A controls the first motor 3-A in such a way that the first motor 3-A operates according to a predetermined operation pattern, by controlling a power conversion operation in the first amplifier, and the second motor control unit 13-B controls the second motor 3-B in such a way that the second motor 3-B operates according to a predetermined operation pattern, by controlling a power conversion operation in the second amplifier. Note that a number of phases of an AC power supply does not particularly limit the present invention, and an AC power supply may be, for example, a single-phase, three-phase, or multiphase AC power supply. A three-phase AC 400 V power supply, a three-phase AC 200 V power supply, a three-phase AC 600 V power supply, a single-phase AC 100 V power supply, or the like is cited as one example of an AC power supply.

For example, one of the first motor 3-A and the second motor 3-B is a servomotor, and the other is a spindle motor. In the example illustrated in FIG. 1, as one example, the first motor 3-A is a spindle motor, and the second motor 3-B is a servomotor. Further, a number of phases of the first motor 3-A and the second motor 3-B does not particularly limit the present invention, and the first motor 3-A and the second motor 3-B may be, for example, a single-phase, three-phase, or multiphase motor.

The switching unit 11 selectively switches a motor driving the one main axis 2 between two motors, that is, the first motor 3-A and the second motor 3-B. A switching operation by the switching unit 11 is controlled by, for example, the upper control unit 100.

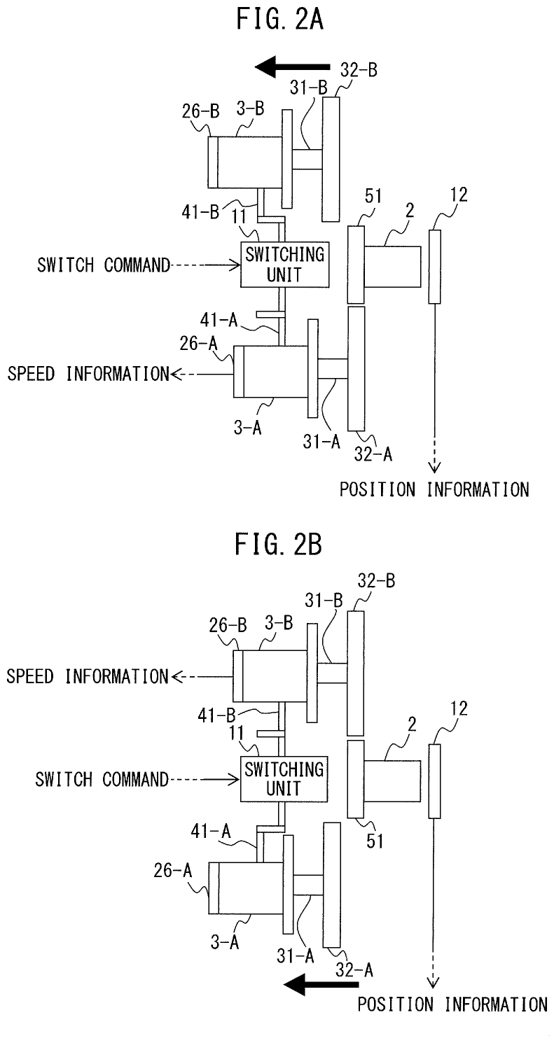

FIGS. 2A and 2B are diagrams illustrating one example of a switching operation by the switching unit in the motor control apparatus according to the embodiment of the present disclosure. The switching unit 11 includes movable portions 41-A and 41-B for selectively switching a motor serving as a drive source of the one main axis 2 between the first motor 3-A and the second motor 3-B. A switching mechanism of the switching unit 11 illustrated in FIGS. 2A and 2B is only one example, and a switching mechanism may be any mechanism for selectively switching a mechanical connection destination of a gear 51 provided on the main axis 2 between a gear 32-A provided on a rotary shaft 31-A of the first motor 3-A and a gear 32-B provided on a rotary shaft 31-B of the second motor 3-B.

For example, as illustrated in FIG. 2A, when the main axis 2 is driven by the first motor 3-A, the switching unit 11 separates the gear 32-B provided on the rotary shaft 31-B of the second motor 3-B from the gear 51 provided on the main axis 2, by operating the movable portion 41-B. In this case, the gear 32-A provided on the rotary shaft 31-A of the first motor 3-A and the gear 51 provided on the main axis 2 are in a state of being connected (hereinafter, simply described that “the first motor 3-A is connected to the main axis 2” in some cases), and rotation force of the rotary shaft 31-A of the first motor 3-A is transmitted to the main axis 2.

Further, for example, as illustrated in FIG. 2B, when the main axis 2 is driven by the second motor 3-B, the switching unit 11 separates the gear 32-A provided on the rotary shaft 31-A of the first motor 3-A from the gear 51 provided on the main axis 2, by operating the movable portion 41-A. In this case, the gear 32-B provided on the rotary shaft 31-B of the second motor 3-B and the gear 51 provided on the main axis 2 are in a state of being connected (hereinafter, simply described that “the second motor 3-B is connected to the main axis 2” in some cases), and rotation force of the rotary shaft 31-B of the second motor 3-B is transmitted to the main axis 2.

One position detection unit 12 is provided in order to detect position information of the main axis 2. In the present embodiment, the position information detected by the position detection unit 12 is input to the first motor control unit 13-A and the second motor control unit 13-B. As the position detection unit 12, for example, there is an encoder and the like.

The first motor control unit 13-A controls the first motor 3-A by use of the position information of the main axis 2 input from the position detection unit 12. Thus, the first motor control unit 13-A includes a position command generation unit 21-A, a subtracter 22-A, a position control unit 23-A, a subtracter 24-A, and a speed control unit 25-A. The position command generation unit 21-A generates a position command by control of the upper control unit 100. The subtracter 22-A calculates a difference between the position command and the position information of the main axis 2 detected by the position detection unit 12, and the position control unit 23-A generates a speed command that the difference becomes zero. For speed command generation processing by the position control unit 23-A, for example, P control, PI control, or PID control is used. The subtracter 24-A calculates a difference between a speed command and speed information of the first motor 3-A detected by a speed detection unit 26-A, and the speed control unit 25-A generates such a current command that the difference becomes zero. For current command generation processing by the speed control unit 25-A, for example, PI control or PID control is used. A power conversion operation of the first amplifier (not illustrated) is controlled based on a current command generated by the speed control unit 25-A, and the first amplifier outputs AC power for driving the first motor 3-A. The first motor 3-A is driven by the AC power output from the first amplifier. When the first motor 3-A is connected to the main axis 2, rotation force of the rotary shaft 31-A of the first motor 3-A is transmitted to the main axis 2. Note that a configuration of the first motor control unit 13-A defined herein is one example, and, for example, a configuration of the first motor control unit 13-A may be specified, including terms such as a current control unit, a torque command generation unit, and a switching command generation unit.

The second motor control unit 13-B controls the second motor 3-B by use of the position information of the main axis 2 input from the position detection unit 12. Thus, the second motor control unit 13-B includes a position command generation unit 21-B, a subtracter 22-B, a position control unit 23-B, a subtracter 24-B, and a speed control unit 25-B. The position command generation unit 21-B generates a position command by control of the upper control unit 100. The subtracter 22-B calculates a difference between the position command and the position information of the main axis 2 detected by the position detection unit 12, and the position control unit 23-B generates such a speed command that the difference becomes zero. For speed command generation processing by the position control unit 23-B, for example, P control, PI control, or PID control is used. The subtracter 24-B calculates a difference between the speed command and the speed information of the second motor 3-B detected by a speed detection unit 26-B, and the speed control unit 25-B generates a current command that the difference becomes zero. For current command generation processing by the speed control unit 25-B, for example, PI control or PID control is used. A power conversion operation of the second amplifier (not illustrated) is controlled based on a current command generated by the speed control unit 25-B, and the second amplifier outputs AC power for driving the second motor 3-B. The second motor 3-B is driven by the AC power output from the second amplifier. When the second motor 3-B is connected to the main axis 2, rotation force of the rotary shaft 31-B of the second motor 3-B is transmitted to the main axis 2. Note that a configuration of the second motor control unit 13-B defined herein is one example, and, for example, a configuration of the second motor control unit 13-B may be specified, including terms such as a current control unit, a torque command generation unit, and a switching command generation unit.

In this way, the first motor 3-A is controlled by the first motor control unit 13-A, and the second motor 3-B is controlled by the second motor control unit 13-B. When the main axis 2 is driven by the first motor 3-A, the switching unit 11 connects the gear 32-A provided on the rotary shaft 31-A of the first motor 3-A to the gear 51 provided on the main axis 2, and thereby, rotation force of the rotary shaft 31-A of the first motor 3-A is transmitted to the main axis 2. Similarly, when the main axis 2 is driven by the second motor 3-B, the switching unit 11 connects the gear 32-B provided on the rotary shaft 31-B of the second motor 3-B to the gear 51 provided on the main axis 2, and thereby, rotation force of the rotary shaft 31-B of the second motor 3-B is transmitted to the main axis 2.

The abnormality detection unit 14 detects abnormality of a motor driving the main axis 2, between the first motor 3-A and the second motor 3-B. Herein, a “motor driving the main axis 2” is a motor (that is, a motor having a rotary shaft provided with a gear connected to the gear 51 provided on the main axis 2) connected to the main axis 2 by a switching operation of the switching unit 11, between the first motor 3-A and the second motor 3-B. A detection result by the abnormality detection unit 14 is reported to the safety control unit 15.

As abnormality that can occur in a motor, there are abnormality of a motor rotation speed, an abnormal load on a motor, overcurrent and low current in a motor winding, overvoltage and low voltage between motor terminals, abnormal heat generation of a motor, abnormal vibration of a motor, abnormal odor of a motor, abnormal noise during motor rotation, and the like. Abnormality of a motor rotation speed can be detected based on speed information acquired by the speed detection unit 26-A and the speed detection unit 26-B. An abnormal load on a motor can be detected based on, for example, a measurement result by a force sensor, or a calculation result based on a motor rotation speed and current of a motor winding. Note that, since a motor being an abnormality detection target is connected to the main axis 2, an abnormal load on the main axis 2 connected to the motor can be interpreted as being also included in an “abnormal load on a motor”. With regard to this, an abnormal load on the main axis 2 (that is, an abnormal load on a motor) may be detected based on position information of the main axis 2. Further, overcurrent and low current in a motor winding can be detected based on a current value acquired by a current detector (not illustrated) provided in the motor winding. Overvoltage and no voltage between motor terminals can be detected based on a voltage value acquired by a voltage detector (not illustrated) provided between the motor terminals. Abnormal heat generation of a motor can be detected based on temperature acquired by a temperature sensor (not illustrated) provided near the motor. Abnormal vibration of a motor can be detected based on information acquired by a vibration sensor (not illustrated), acceleration sensor (not illustrated), a camera (not illustrated), or the like provided near the motor. Abnormal odor of a motor can be detected based on information acquired by an odor sensor (not illustrated) provided near the motor. Abnormal noise during motor rotation can be detected based on information acquired by a microphone provided near the motor. Alternatively, the abnormality detection unit 14 may determine that abnormality has occurred in a motor driving the main axis 2, when receiving an alarm signal output from each of various sensors disposed in a motor, peripheral equipment of a motor, or the like. For example, an alarm signal is output from a speed detection unit when a data error occurs due to influence of noise in the speed detection unit or when the speed detection unit fails and the speed detection unit itself detects the failure, and the abnormality detection unit 14 may determine that abnormality has occurred in the motor driving the main axis 2, when receiving such an alarm signal.

When the abnormality detection unit 14 detects abnormality of a motor driving the main axis 2, the safety control unit 15 controls the switching unit 11 to switch the motor driving the main axis 2, from the motor in which the abnormality is detected to a motor in which no abnormality is detected, and also controls the motor control unit to stop the motor in which no abnormality is detected to stop the main axis 2. In other words, when the abnormality detection unit 14 detects the abnormality of the motor driving the main axis 2, the safety control unit 15 outputs a switch command to the switching unit 11, and outputs a stop command to the motor control unit for controlling the motor after switching (that is, the motor in which no abnormality is detected).

For example, in a case where the main axis 2 is driven by the first motor 3-A (FIG. 2A), when the abnormality detection unit 14 detects abnormality of the first motor 3-A, the safety control unit 15 controls the switching unit 11 and thus switches a motor driving the main axis 2, from the first motor 3-A (the motor in which the abnormality is detected) to the second motor 3-B (the motor in which no abnormality is detected) (FIG. 2B), and also controls the second motor control unit 13-B and thus gradually decelerates and finally stops the second motor 3-B. In a state where the second motor 3-B is connected to the main axis 2, the main axis 2 is stopped by stopping the second motor 3-B by control of the safety control unit 15.

Furthermore, for example, in a case where the main axis 2 is driven by the second motor 3-B (FIG. 2B), when the abnormality detection unit 14 detects abnormality of the second motor 3-B, the safety control unit 15 controls the switching unit 11 and thus switches a motor driving the main axis 2, from the second motor 3-B (the motor in which abnormality is detected) to the first motor 3-A (the motor in which no abnormality is detected) (FIG. 2A), and also controls the first motor control unit 13-A and thus gradually decelerates and finally stops the first motor 3-A. In a state where the first motor 3-A is connected to the main axis 2, the main axis 2 is stopped by stopping the first motor 3-A by control of the safety control unit 15.

As described above, the first motor control unit 13-A controls the first motor 3-A in such a way that the first motor 3-A operates according to a predetermined operation pattern, by controlling a power conversion operation in the first amplifier (not illustrated), and the second motor control unit 13-B controls the second motor 3-B in such a way that the second motor 3-B operates according to a predetermined operation pattern, by controlling a power conversion operation in the second amplifier (not illustrated). Therefore, stop control of the first motor 3-A and stop control of the second motor 3-B by the safety control unit 15 are achieved by inputting a stop command generated by the safety control unit 15 to a motor control unit (either the first motor control unit 13-A or the second motor control unit 13-B) for controlling a motor in which no abnormality is detected, and controlling a power conversion operation in a corresponding amplifier (either the first amplifier or the second amplifier) by the motor control unit. In other words, the first motor control unit 13-A or the second motor control unit 13-B outputs, to a semiconductor switching element in an inverter constituting a corresponding amplifier, such a switching command that AC power for motor driving output from the inverter decreases. For example, when an inverter constituting each of the first amplifier and the second amplifier is a PWM inverter, an on command and an off command are alternately output while a ratio of an off command to an on command for a semiconductor switching element is gradually increased, and only an off command is finally output, and consequently, the motor is gradually decelerated, and finally stopped. In other words, the main axis 2 driven by the motor is gradually decelerated, and finally stopped.

Note that, in the example illustrated in FIG. 1, it is assumed that stop control of the first motor 3-A and stop control of the second motor 3-B by the safety control unit 15 are achieved by controlling power conversion operations of the first amplifier and the second amplifier via the first motor control unit 13-A and the second motor control unit 13-B, respectively. As an alternative example hereof, the safety control unit 15 may directly control power conversion operations of the first amplifier and the second amplifier, and thereby, stop control of the first motor 3-A and stop control of the second motor 3-B may be achieved. In this case, the safety control unit 15 outputs, to a semiconductor switching element in an inverter constituting a corresponding amplifier, such a switching command that AC power for motor driving output from the inverter decreases.

In this way, according to the present embodiment, in the motor control apparatus 1 for selectively switching a motor driving one main axis 2 between two motors (the first motor 3-A and the second motor 3-B), when abnormality occurs in the motor driving the main axis 2, the main axis 2 is stopped by switching the motor driving the main axis 2 by the switching unit 11, from the motor in which the abnormality is detected to the motor in which no abnormality is detected, and controlling a motor control unit and thus stopping the motor in which no abnormality is detected, and therefore safety of the main axis 2 can be ensured even when the motor has abnormality. Note that, in the present embodiment, when abnormality of the motor driving the main axis 2 occurs, the switching unit 11 separates the main axis 2 from the motor in which the abnormality is detected, and then connects the main axis 2 to the motor in which no abnormality is detected, and therefore, in order to smoothly perform a switching operation by the switching unit 11 when abnormality of the motor occurs as well, it is preferable that the gear 32-A provided on the rotary shaft 31-A of the first motor 3-A and the gear 32-B provided on the rotary shaft 31-B of the second motor 3-B are rotating at a same speed. To this end, for example, during a normal operation (that is, when both the motors have no abnormality), the first motor control unit 13-A and the second motor control unit 13-B have only to control the first motor 3-A and the second motor 3-B in such a way that the gear 32-A provided on the rotary shaft 31-A of the first motor 3-A and the gear 32-B provided on the rotary shaft 31-B of the second motor 3-B always rotate at a same speed. Further, for example, during a normal operation (that is, when both the motors have no abnormality), a motor driving the main axis 2 is rotationally controlled, and a motor which does not drive the main axis 2 is not rotationally controlled, whereas, when abnormality of a motor occurs, a motor which does not drive the main axis 2 (that is, a motor in which no abnormality is detected) is rapidly accelerated, and a switching operation by the switching unit 11 may be performed after a gear provided on a rotary shaft of the motor becomes a same speed as a gear provided on a rotary shaft of a motor driving the main axis 2 (that is, a motor in which abnormality is detected).

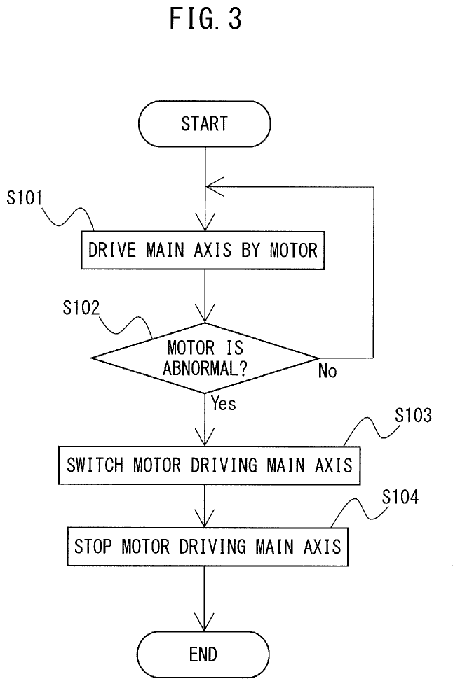

FIG. 3 is a flowchart illustrating an operation flow of the motor control apparatus according to the embodiment of the present disclosure.

When one of two motors (the first motor 3-A and the second motor 3-B) is connected to the one main axis 2 and then driven by the motor control apparatus 1 according to the present embodiment (step S101), the abnormality detection unit 14 determines whether abnormality has occurred in a motor driving the main axis 2, in step S102. The operation flow advances to step S103 when the abnormality detection unit 14 determines in step S102 that abnormality has occurred in the motor driving the main axis 2, and the operation flow returns to step S101 otherwise.

In step S103, the safety control unit 15 controls the switching unit 11 and thus switches the motor driving the main axis 2, from the motor in which the abnormality is detected to a motor in which no abnormality is detected.

In step S104, the safety control unit 15 outputs a stop command to a motor control unit for controlling a motor in which no abnormality is detected (that is, a motor after switching), and gradually decelerates and finally stops the motor in which the abnormality is not detected. Thereby, the main axis 2 is stopped.

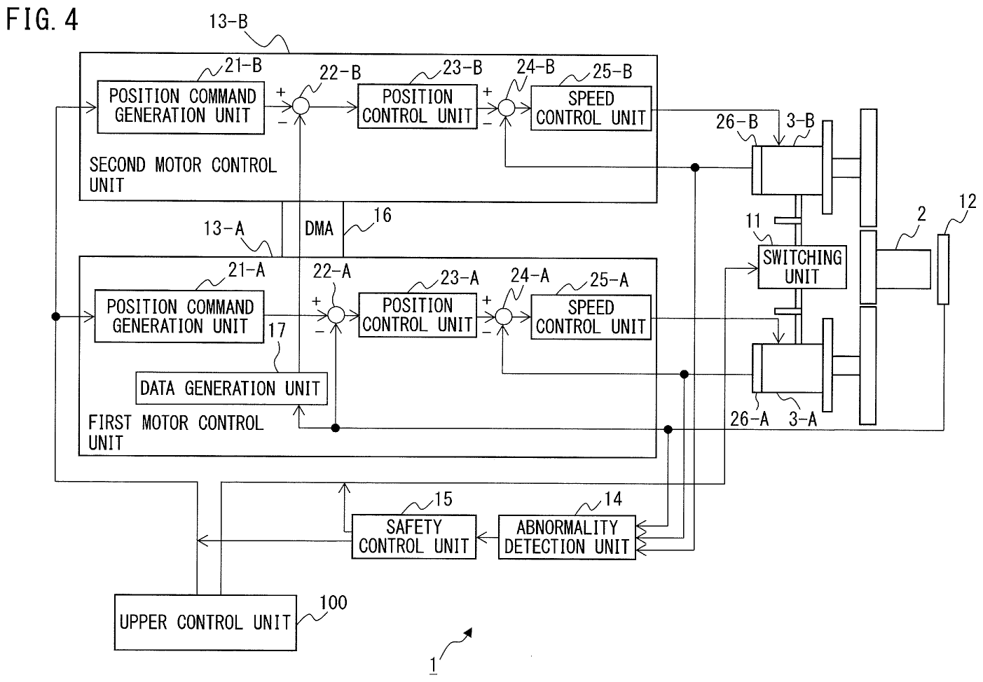

Next, a motor control apparatus according to a further embodiment of the present disclosure will be described. FIG. 4 is a diagram illustrating the motor control apparatus according to the further embodiment of the present disclosure.

A motor control apparatus 1 according to the further embodiment of the present disclosure further includes, in the motor control apparatus 1 described with reference to FIGS. 1 to 3, a data transfer unit 16 for transferring data between two motor control units (that is, between the first motor control unit 13-A and the second motor control unit 13-B), and a data generation unit 17 for generating transfer data including at least position information as data to be transferred by the data transfer unit 16.

Data transfer is performed between the first motor control unit 13-A and the second motor control unit 13-B by the data transfer unit 16. The data transfer unit 16 transfers data between the first motor control unit 13-A and the second motor control unit 13-B using a direct memory access (DMA) transfer scheme. The DMA transfer scheme is a scheme directly performing data transfer between peripheral equipment and a main memory (RAM) or the like without intervention of a CPU, and data transfer is controlled by a DMA controller built in a chip set of a mother board provided in each of the first motor control unit 13-A and the second motor control unit 13-B. A plurality of DMA channels are provided between the first motor control unit 13-A and the second motor control unit 13-B, and data transfer by the data transfer unit 16 is performed by occupying one of the channels. When the data transfer ends, the channel is released, and becomes available to another apparatus.

The first motor control unit 13-A controls the first motor 3-A by use of the position information of the main axis 2 input from the position detection unit 12. Thus, the first motor control unit 13-A includes the position command generation unit 21-A, the subtracter 22-A, the position control unit 23-A, the subtracter 24-A, and the speed control unit 25-A described above, but this is as described with reference to FIG. 1.

Furthermore, the position information of the main axis 2 input to the first motor control unit 13-A is transferred to the second motor control unit 13-B by the data transfer unit 16 using the DMA transfer scheme. While the data transfer unit 16 can transfer various types of data through a plurality of DMA channels, a DMA channel through which data are being transferred is occupied. Accordingly, in the present embodiment, the data generation unit 17 for generating data to be transferred is provided inside the first motor control unit 13-A, a transfer amount of data is reduced, and a resource of a DMA channel is effectively utilized. As data to be transferred to the second motor control unit 13-B from the first motor control unit 13-A by the data transfer unit 16, the data generation unit 17 generates transfer data including at least position information detected by the position detection unit 12. The transfer data including the position information generated by the data generation unit 17 are transferred to the second motor control unit 13-B by the data transfer unit 16 using the DMA transfer scheme.

The second motor control unit 13-B controls the second motor 3-B by use of the position information of the main axis 2 within the transfer data input via the data transfer unit 16. Thus, the second motor control unit 13-B includes the position command generation unit 21-B, the subtracter 22-B, the position control unit 23-B, the subtracter 24-B, and the speed control unit 25-B. The position command generation unit 21-B, the position control unit 23-B, the subtracter 24-B, and the speed control unit 25-B are as described with reference to FIG. 1. The subtracter 22-B calculates a difference between a position command generated by the position command generation unit 21-B and the position information transferred from the first motor control unit 13-A by the data transfer unit 16, and the position control unit 23-B generates such a speed command that the difference becomes zero.

In the further embodiment illustrated in FIG. 4, since circuit components other than the data transfer unit 16, the data generation unit 17, and the subtracter 22-B are similar to circuit components illustrated in FIG. 1, same circuit components are indicated with same reference signs, and detailed descriptions of the circuit components are omitted. Further, an operation flow of the motor control apparatus 1 according to the further embodiment illustrated in FIG. 4 is similar to that illustrated in FIG. 3.

According to the further embodiment illustrated in FIG. 4, since the position information of the main axis 2 input to the first motor control unit 13-A is transferred to the second motor control unit 13-B using the DMA transfer scheme by the data transfer unit 16 for transferring data between the first motor control unit 13-A for controlling the first motor 3-A and the second motor control unit 13-B for controlling the second motor 3-B, the position information of the main axis 2 is shared by control of two motors without providing additional hardware, and the efficient driving and safety of the main axis 2 can be ensured.

The first motor control unit 13-A, the second motor control unit 13-B, the abnormality detection unit 14, the safety control unit 15, and the upper control unit 100 in each of the embodiments described above may be built, for example, in a form of a software program or may be built by a combination of various types of electronic circuits and a software program. In this case, for example, a function of each unit may be achieved by causing an arithmetic processing device such as an MPU or a DSP to operate the software program. Alternatively, the functions of the first motor control unit 13-A, the second motor control unit 13-B, the abnormality detection unit 14, the safety control unit 15, and the upper control unit 100 may be achieved as a semiconductor integrated circuit on which a software program providing the functions is written. Further, at least one of the first motor control unit 13-A, the second motor control unit 13-B, the abnormality detection unit 14, the safety control unit 15, and the upper control unit 100 may be provided inside a numerical value control apparatus of a machine tool.

According to one aspect of the present disclosure, in a motor control apparatus for selectively switching a motor driving one main axis between two motors, safety of a main axis can be ensured even when a motor has abnormality.

1. A motor control apparatus comprising:
a switching unit configured to selectively switch a motor driving one main axis between two motors;
a position detection unit configured to detect position information of the main axis;
two motor control units being provided correspondingly to each of the two motors, and each configured to control the motor by use of the position information;
an abnormality detection unit configured to detect abnormality of a motor driving the main axis between the two motors; and
a safety control unit configured to control the switching unit to switch the motor driving the main axis, from the motor in which the abnormality is detected to a motor in which the abnormality is not detected, and also to control the motor control unit to stop the motor in which the abnormality is not detected to stop the main axis, when the abnormality detection unit detects abnormality of the motor driving the main axis.

2. The motor control apparatus according to claim 1, further comprising:
a data transfer unit for transferring data between the two motor control units; and
a data generation unit for generating transfer data including at least the position information as data to be transferred by the data transfer unit.

3. The motor control apparatus according to claim 2, wherein
the position information detected by the position detection unit is input to the first motor control unit between the two motor control units, and
the transfer data generated by the data generation unit provided inside the first motor control unit are transferred to the second motor control unit between the two motor control units via the data transfer unit.

4. The motor control apparatus according to claim 2, wherein
the data transfer unit transfers data using a DMA transfer scheme.

5. The motor control apparatus according to claim 1, wherein
one of the two motors is a servomotor, and the other is a spindle motor.
